(19) United States
(12) Patent Application Publication
(10) Pub. No.: US 2025/0284934 A1
(43) Pub. Date: Sep. 11, 2025

(54) SPLINE BASED TRANSFORMER

(71) Applicants: DISNEY ENTERPRISES, INC., Burbank, CA (US); ETH Zürich (Eidgenössische Technische Hochschule Zürich), Zürich (CH)

(72) Inventors: Moritz Niklaus Bächer, Zürich (CH); Prashanth Chandran, Zürich (CH); Agon Serifi, Zürich (CH)

(21) Appl. No.: 19/062,334

(22) Filed: Feb. 25, 2025

Related U.S. Application Data
(60) Provisional application No. 63/562,102, filed on Mar. 6, 2024.

(51) Int. Cl. G06N 3/0455

(52) U.S. Cl. CPC G06N 3/0455

(57) ABSTRACT

In one embodiment, a method for generating an output sequence of data utilizing a spline-based transformer is disclosed. The method may include encoding, via a processing element, an input sequence of data using an artificial neural network encoder to generate a plurality of input tokens; processing, via the processing element, the plurality of input tokens and a plurality of control tokens with a transformer encoder into a latent space to generate a plurality of control points; defining, via the processing element, a spline based on the plurality of control points; sampling, via the processing element, a plurality of interpolated control points based on the spline; and decoding, via the processing element, the interpolated control points with an artificial neural network decoder to generate the output sequence of data.

### CROSS-REFERENCE TO RELATED APPLICATIONS

This present application claims priority to U.S. Provisional Application No. 63/562,102 filed on Mar. 6, 2024 entitled “Spline-Based Transformer,” which is hereby incorporated by reference herein in its entirety.

### BACKGROUND

Positional encoding is traditionally an important component in transformer models. It infuses positional information into input tokens to help transformers learn position-agnostic token embeddings. Positional encoding works by (1) pre-assigning sinusoids of different frequencies and phases to every position an input token can take on in a sequence, and (2) by adding this sinusoid to the token embedding that appears at the corresponding position in the sequence. Injecting a token with positional information, also referred to as absolute position encoding in later work, has evolved into several variants. For example, several works have shown that absolute position encoding limits the ability of transformers to handle longer sequences at inference time and proposed relative position encoding schemes where a fixed or learned bias is added to the attention matrix. Irrespective of their exact arrangement, transformer architectures generally employ a combination of absolute and relative position encoding schemes.

Positional encoding assumes that token embeddings represent elemental data in a collection, e.g., individual words in a sentence, images in a video, or poses in an animation, and that an additional notion of position is required to model a collection of such elements, such as sequences of words, images, or animation frames. This process decouples elemental and collective datatypes and forces a model to learn separate representations for the elements and the collection as a whole. Additionally, most existing architectures that learn compact neural representations for collections do not leverage the fact that individual elements, traversed in a particular order, make up a collection.

The term positional encoding is used in the literature of coordinate-based neural networks to refer to a frequency encoding scheme for improvement of network training wherein a low dimensional input (such as a 3D position) is mapped to a higher dimension using a collection of sinusoids of different frequencies. As used herein, positional encoding represents a mechanism to introduce positional information into inputs and outputs that are otherwise devoid of any positional information.

Transformers were introduced as an alternative to traditional sequence models such as recurrent neural networks (RNNs) and long short-term memories (LSTMs). While they initially were used on language tasks, their effectiveness as a general purpose neural architecture led to their adoption as image models, in speech recognition, 3D and 4D modeling, and as architectures for diffusion models.

The original transformers relied on absolute position encoding with sinusoids to inject positional and temporal information into input tokens. Soon after, researchers identified sequence length extrapolation and overfitting as limitations of absolute positional encoding and introduced several extensions to combat them, such as Rotary Position Embeddings (RoPE) where absolute positions are encoded as a rotation matrix and relative token positions are explicitly taken into account during attention computations for better performance and generalization. Similarly, with the Text-to-Text Transfer Transformer (T5) transformer a learned bias that depends on the relative distance between tokens is added to the attention matrix. The Attention with Linear Biases (ALiBi) transformer showed that a fixed bias with a predetermined slope that depends on the attention head can improve the performance for unseen sequence lengths. An extension to ALiBi, which applied ideas from ROPE, further improved the performance of ALiBi in language tasks. Positional encoding with a randomized ordering of sinusoids to account for longer test positions by augmenting the training distribution addressed the extrapolation problem. Transformers with no positional encoding (NoPE) may outperform most commonly used forms of position encoding in decoder only tasks.

However, for transformers used in learning condensed latent spaces of sequential data, current methods make use of a transformer autoencoder with relative position encoding and an additional classification (CLS) token as input. In these applications, the transformer encoder aggregates information from the input data tokens into the CLS token, which is then interpreted as a condensed latent descriptor of the input sequence at the encoder's output. This latent descriptor token is appropriately position-encoded and passed through a transformer decoder to reconstruct the input. For such scenarios, the use of no positional encoding (NoPE) is not a viable solution as it reduces to an n-fold duplication of the latent descriptor, therefore passing an identical or static latent sequence to the decoder. Without any variation in its input or absolute positional encoding, the decoder fails to reconstruct the original input sequence. Improved transformer-based artificial intelligence systems are needed to overcome these problems.

### BRIEF SUMMARY

In one embodiment, a method for generating an output sequence of data utilizing a spline-based transformer is disclosed. The method may include encoding, via a processing element, an input sequence of data using an artificial neural network encoder to generate a plurality of input tokens; processing, via the processing element, the plurality of input tokens and a plurality of control tokens with a transformer encoder into a latent space to generate a plurality of control points; defining, via the processing element, a spline based on the plurality of control points; sampling, via the processing element, a plurality of interpolated control points based on the spline; and decoding, via the processing element, the interpolated control points with an artificial neural network decoder to generate the output sequence of data.

Optionally, in some embodiments, the processing step includes appending the plurality of control tokens to the plurality of input tokens.

Optionally, in some embodiments, the method further includes determining a plurality of respective weights of the plurality of control points based on a basis function, wherein the spline comprises a weighted sum based on the plurality of respective weights.

Optionally, in some embodiments, the method further includes learning, via the processing element, the plurality of control tokens.

Optionally, in some embodiments, the spline includes a continuous latent space trajectory.

Optionally, in some embodiments, the trajectory encapsulates a characteristic of the input sequence of data.

Optionally, in some embodiments, the sampling step includes uniformly or non-uniformly discretizing the spline.

Optionally, in some embodiments, the method further includes deriving, via the processing element, embeddings for the plurality of input tokens before processing the plurality of input tokens and the plurality of control tokens with the transformer encoder.

Optionally, in some embodiments, the method further includes manipulating, via the processing element, the output sequence of data by adjusting at least one of a position or a value of the plurality of control points within the latent space.

Optionally, in some embodiments, the manipulating adjusts a temporal characteristic of output sequence of data.

Optionally, in some embodiments, the temporal characteristic includes at least one of a speed or trajectory change in the output sequence of data.

Optionally, in some embodiments, the spline includes a B-spline.

Optionally, in some embodiments, an alteration to a control point of the plurality of control points affects a limited segment of the trajectory.

In another embodiment, a non-transitory computer-readable storage medium is disclosed. The computer-readable storage medium may include instructions that when executed by a computer, cause the computer to: encode an input sequence of data using an artificial neural network encoder to generate a plurality of input tokens; process the plurality of input tokens and a plurality of control tokens with a transformer encoder into a latent space to generate a plurality of control points; define a spline based on the plurality of control points; sample a plurality of interpolated control points based on the spline; and decode the interpolated control points with an artificial neural network decoder to generate an output sequence of data.

Optionally, in some embodiments, the processing step includes appending the plurality of control tokens to the input tokens.

Optionally, in some embodiments, the instructions may further include determining a plurality of respective weights of the plurality of control points based on a basis function, wherein the spline includes a weighted sum based on the plurality of respective weights.

Optionally, in some embodiments, the instructions may further include learning, via the processing element, the plurality of control tokens.

Optionally, in some embodiments, the spline comprises a continuous latent space trajectory.

Optionally, in some embodiments, the trajectory encapsulates a characteristic of the input sequence of data.

In another embodiment, a method for generating an output sequence of data utilizing a spline-based transformer is disclosed. The method may include processing, via a processing element, a plurality of input tokens and a plurality of control tokens with a transformer encoder into a latent space to generate a plurality of control points; defining, via the processing element, a spline based on the plurality of control points; interpolating, via the processing element, a plurality of interpolated control points based on the spline; and decoding, via the processing element, the interpolated control points to generate the output sequence of data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of an example of a spline-based transformer disclosed herein.

FIG. 2 is a flow diagram for generating an output sequence based on an input sequence with the spline-based transformer of FIG. 1.

FIG. 3 is a table of examples of outputs of a spline-based transformer of FIG. 1 compared to two prior methods.

FIG. 4 illustrates a plurality of facial expression reconstructions generated with a spline-based transformer of FIG. 1.

FIG. 5 illustrates examples of reconstructing a character using a spline-based transformer of FIG. 1 compared to two prior methods.

FIG. 6 is a simplified block diagram of components of a computing system of the microclimate prediction system of FIG. 1.

### DETAILED DESCRIPTION

Disclosed herein are transformer-based artificial intelligence systems and training methods that use control points in latent space that form a spline. The spline-based transformers disclosed herein encode an input sequence of data (e.g., image frames, words, movements, etc.) and combine this input data with learnable control tokens into a trajectory in latent space. The trajectory is defined by the latent control points of a curve.

Spline-based transformers present an approach to learning condensed latent spaces for sequential data using a transformer autoencoder that may not require a positional encoding. In addition to providing significant performance benefits, spline-based transformers provide a novel control mechanism to navigate the latent spaces. The architecture of the spline-based transformer is constructed around a transformer autoencoder model, which incorporates a latent space between the encoder and decoder components.

In many embodiments, an artificial neural network (ANN), such as a multi-layer perceptron (MLP) processes the input data into one or more input tokens. The system combines the input tokens with one or more control tokens before being decoded by a transformer decoder.

In many embodiments, the output of the transformer decoder is one or more control points in latent space. A latent space is often a high-dimensional space that represents the internal structure of the input data in a compressed and often abstract form. Latent space is created during the training of the spline-based transformers. In many embodiments, the input data is encoded into a lower-dimensional representation. The latent space captures features and patterns of the input data, allowing for manipulation and analysis of data by the spline-based transformers disclosed.

In many embodiments, the spline is interpolated at one or more points in latent space to generate one or more interpolated control points. The interpolated control points are decoded by an ANN (which may be the same or different ANN that encoded the input data) to generate an output sequence.

Although in many examples disclosed herein, a spline-based transformer is used for image generation, such as creating animation frames, spline-based transformers may be used for many applications including, but not limited to language processing, machine translation, text summarization, sentiment analysis, question answering, text generation, image classification, object detection, image generation, speech recognition, text-to-speech, image captioning, video analysis, etc.

As disclosed herein, learned neural representations for elemental and collective datatypes do not have to be decoupled from one another. Instead, they can be effectively represented in a single, shared latent space. A collection can be represented by learning to traverse a trajectory in the latent space of elemental data. A spline-based transformer is a class of transformer models based on splines. Spline-based transformers do not require absolute position encoding, which is a benefit over existing transformers. For example, absolute positional encoding in existing transformer models can be a limitation because it restricts the model's ability to generalize to sequences of varying lengths or shifts. This is due to the fixed nature of the positions assigned to tokens, meaning that each position is encoded with a specific vector regardless of context. This can be problematic because it causes a lack of flexibility in the model, results in poor generalization, and an inability to handle variations in sequence order.

Examples demonstrate the superior performance of a spline-based transformer over transformers with conventional positional encoding on several datasets and applications, including synthetic data, images, animation data, and in representing challenging geometry like hair strands. Additionally, spline-based transformers allow users to manipulate a given collection by directly interacting with corresponding latent controls, thereby introducing a new means of interacting with this architecture. Simple control mechanisms to manipulate a latent space are automatically learned by spline-based transformers and allow for rapid manipulation of the output sequence. With transformers gaining significant attention in recent years as general purpose architectures, spline-based transformers may be leveraged across multiple disciplines for a wide variety of tasks.

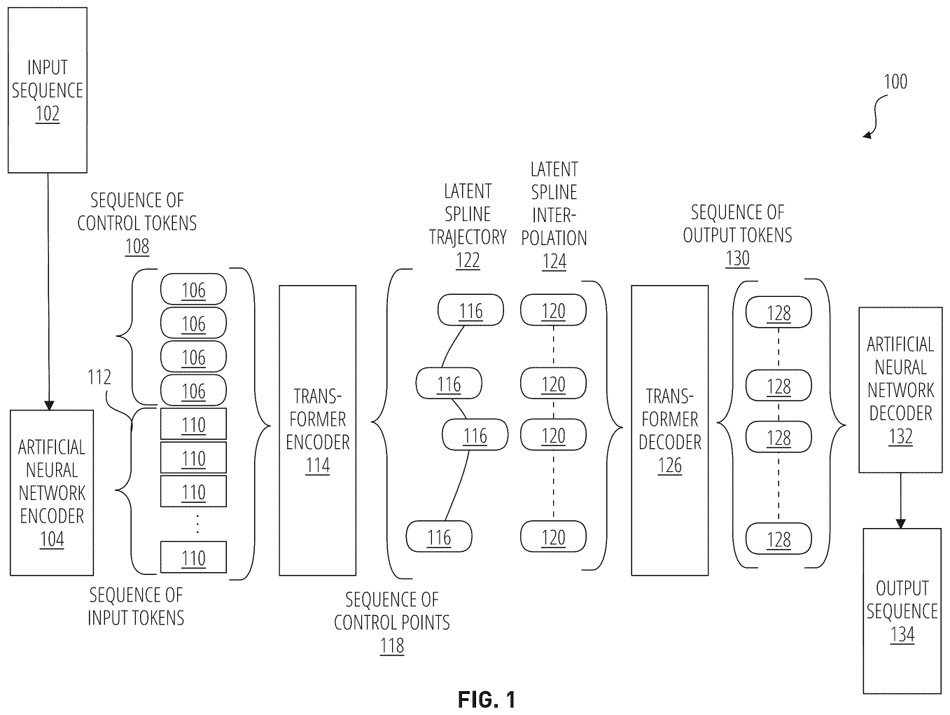

Turning to the figures, FIG. 1 illustrates an example schematic of a spline-based transformer 100. The spline-based transformer 100 uses a transformer-based encoder with additional learned control tokens 106 to reduce an input collection of elements to a fixed number of latent control points 116. These control points 116 are interpreted as the control points 116 of a d-dimensional spline in latent space, representing a continuous latent space trajectory. The trajectory encapsulates the fundamental characteristics of the elements constituting the input collection. In some embodiments, uniformly sampling or discretizing the spline and processing the trajectory through the transformer-based decoder reconstructs the original input sequence 102. In some embodiments, the spline may be non-uniformly discretized. For example, the spline-based transformer 100 requires no sinusoidal positional encoding and, therefore, may circumvent the downsides of traditional absolute position encoding, including poor extrapolation, overfitting, etc. The spline-based transformer 100 encodes an input sequence 102, together with learnable sequence of control tokens 108, into a trajectory in latent space defined by the sequence of control points 118 of a spline curve. The spline-based transformer 100 may include an artificial neural network encoder 104, a transformer encoder 114, a transformer decoder 126, and an artificial neural network decoder 132.

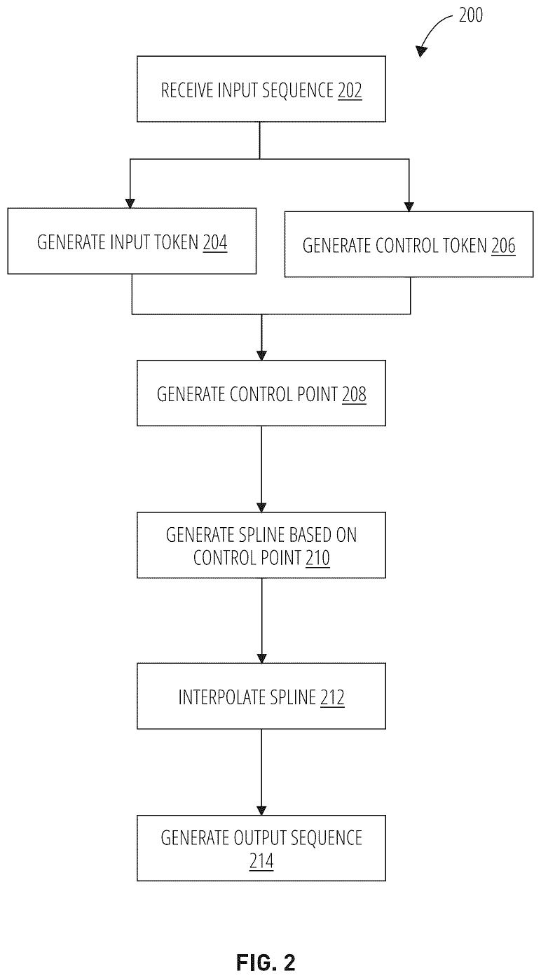

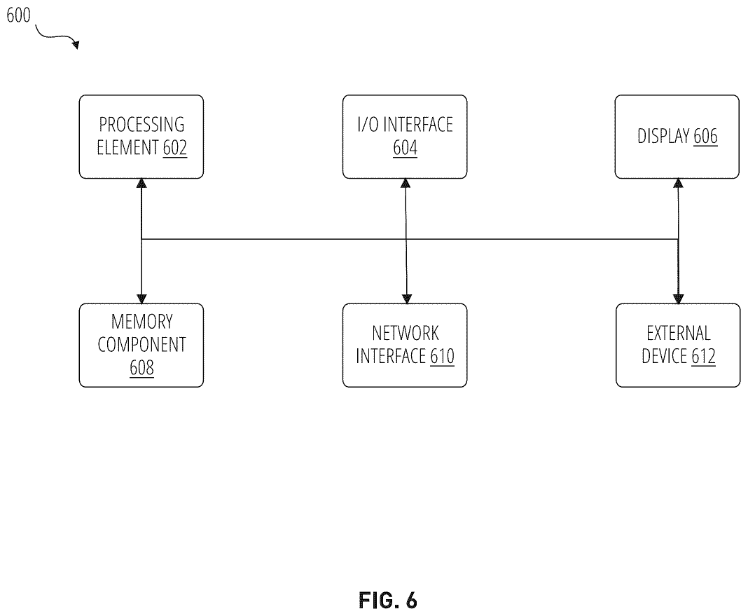

In some embodiments, the spline-based transformer 100 may include an artificial neural network encoder 104. The artificial neural network encoder 104 may be an artificial intelligence system, such as an MLP or a convolutional neural network (CNN). The artificial neural network encoder 104 may be configured to receive an input sequence 102 and encode and/or tokenize the input sequence 102 to generate one or more input tokens 110 to form a sequence of input tokens 112. The input tokens 110 may represent sub-portions of the input sequence 102 and may include information or data corresponding to the sub-portions of the input sequence 102. For example, where the input sequence 102 is a string of text, the artificial neural network encoder 104 may process the input sequence 102 to generate one or more text tokens, where each token represents a word of the input sequence 102. The artificial neural network encoder 104 may be implemented by a computing system 600, as described with respect to FIG. 6. The artificial neural network encoder 104 is described in further detail with respect to FIG. 2.

In some embodiments, the spline-based transformer 100 may include a transformer encoder 114. The transformer encoder 114 may be an artificial neural network, such as a sequence to sequence (seq2seq) encoder, and may be configured to generate a sequence of control points 118 based on the sequence of input tokens 112 generated by the artificial neural network encoder 104 and a sequence of control tokens 108 including one or more learned control tokens 106. The sequence of control points 118 may include one or more latent control points 116, where the control points 116 represent information of the input sequence 102 in a dimensional latent space. For example, the control points 116 may include temporal or positional information of the input sequence 102 and may be relatively positioned in the latent space based on the temporal or positional information.

The transformer encoder 114 may be trained based on a parametric curve family representative of a spline. For example, where the spline is parameterized based on a Bézier curve family, the transformer encoder 114 may be trained on the Bézier curve family. Curve parameters may be randomly sampled according to the parameterization of the curve in a pre-determined domain and used to train the transformer encoder 114. The transformer encoder 114 may be implemented by a computing system 600, as described with respect to FIG. 6.

In some examples, the transformer encoder 114 reduces an input sequence 102 of tokens into a single latent code. Transformers with sequence-to-sequence architectures may require additional pooling mechanisms to condense information from the entire input sequence into a single latent token. This may be accomplished by concatenating an additional learned token (e.g., a control token 106) to the input sequence 102, and by using only the latent representation of the learned token as input to subsequent neural networks (e.g., a transformer decoder 126) or by directly using it in a training objective. The other outputs of the transformer may be discarded. In classification tasks, the learned token is often referred to as the CLS token. To decode the latent CLS token into an output sequence 134, the token may be duplicated, positional encoded appropriately, and passed through a transformer decoder 126 that predicts the output sequence 134. The transformer encoder 114 is described in further detail with respect to FIG. 2.

Instead of appending a single CLS token to the input (as done by older transformers), the spline-based transformers 100 append a collection of ordered control tokens 116 to the input sequence 112 (see, e.g., FIG. 1). Specifically, in some examples, spline-based transformers 100 append n+1 control tokens 116 to the input sequence 112 to obtain a sequence 118 of n+1 control points 116, that will be used to evaluate a latent spline at the output of the encoder with polynomial basis of order k. Latent codes corresponding to each output token are produced by evaluating the spline at the token's position according to Equation 1.

$$s ( t ) = {\sum }_{i = 0}^{n} {N}_{i , k} ( t ) {p}_{i} for t ∈ [ {t}_{k - 1} , {t}_{n + 1} ] , \qquad ( Eq . 1 )$$

The resulting latent spline trajectory 122, s(t), in latent space, has several advantages compared to a traditional positional encoding. First, the latent code is not perturbed by positional information, meaning the decoder does not need to learn to distinguish between positional and contextual information. Second, when using sinusoidals to encode the position of tokens, the contextual part of the token remains fixed and therefore provides a form of redundancy. The latent spline trajectories 122 encode the temporal information implicitly, e.g., they can traverse the latent space faster in certain points and slower in others, making better use of the latent space, compared to older transformers. As discussed further herein the latent spline trajectories 122 are derived from the control points 116 and how they differ from commonly used schemes like ALiBi.

In some embodiments, the spline-based transformer 100 may include a transformer decoder 126. The transformer decoder 126 may be an artificial neural network, and may be configured to process interpolated control points 120 of the dimensional latent space to generate a sequence of output tokens 130 based on the interpolated control points 120. The sequence of output tokens 130 may include one or more output tokens 128 that may be generated to achieve a sequence-to-sequence task. For example, the transformer decoder 126 may process dimensional latent representations of a sequence of input tokens to predict one or more output tokens 128. In some examples, the transformer decoder 126 may use the same structure as the transformer encoder 114.

In some embodiments, the spline-based transformer 100 may include an artificial neural network decoder 132. The artificial neural network decoder 132 may be an artificial intelligence transformer decoder system, such as an MLP or CNN. In some examples, the artificial neural network decoder 132 may use the same structure as the artificial neural network encoder 104. The artificial neural network decoder 132 is configured to process a sequence of output tokens 130 to generate an output sequence 134. For example, the artificial neural network decoder 132 may process one or more output tokens 128 to generate an output sequence 134. For example, for an image reconstruction task, the spline-based transformer 100 may receive an input sequence 102 representative of an image. Based on the generated interpolated control point 120 of the input sequence 102, the artificial neural network decoder 132 may generate an output sequence 134 that reconstructs the image of the input sequence 102. The artificial neural network decoder 132 may be implemented by a computing system 600, as described with respect to FIG. 6. The artificial neural network decoder 132 is described in further detail with respect to FIG. 2.

The spline-based transformer 100 may be implemented by or at a computing device or combinations of computing resources in various embodiments. In various examples, the spline-based transformer 100 may be implemented by one or more servers, cloud computing resources, and/or other computing devices. The spline-based transformer 100 may, for example, be incorporated as a module within a mobile application, software application, or a website presented through a web browser (e.g., at a laptop or desktop computer), and the like.

The components of FIG. 1 are exemplary only. In various examples, the spline-based transformer 100 may communicate with and/or include additional components and/or functionality not shown in FIG. 1. For example, the spline-based transformer 100 may include a control token encoder system.

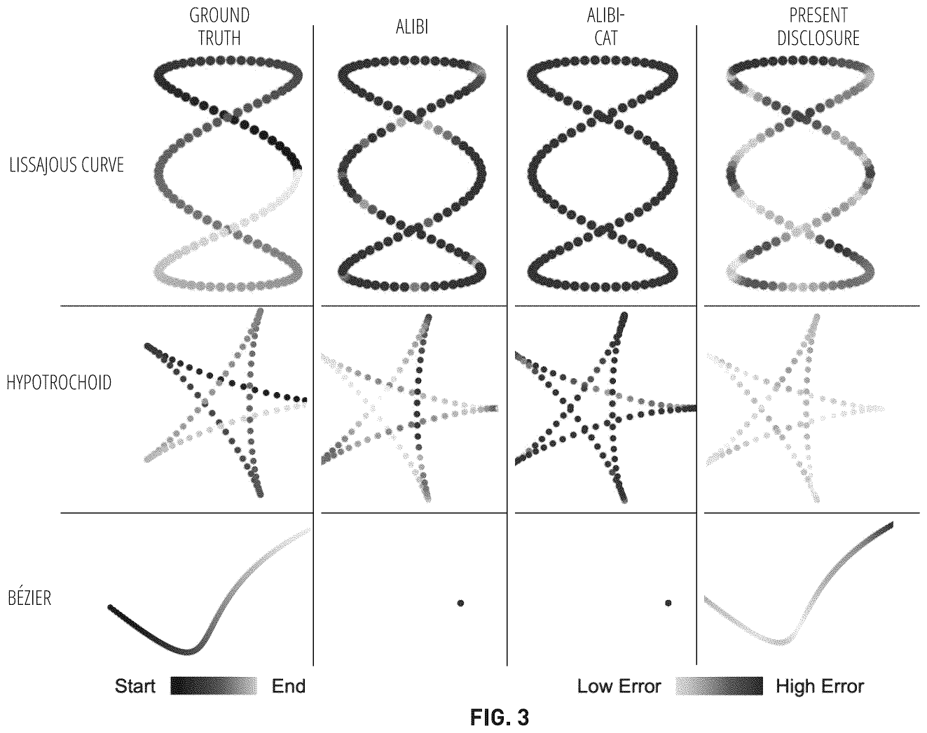

In some examples, splines may be used in function approximation, computer-aided design, and the specification and editing of animation curves in computer graphics (e.g., as shown for example in FIG. 3). Splines provide a means to define a curve or a trajectory with a discrete set of control points. Adjustments to control points have only a local effect, and the degree of the polynomial basis provides users with control over the smoothness of a curve.

The spline-based transformer 100 modeling may be agnostic to the specific spline representation. In some examples, the spline-based transformer 100 incorporates a B-Spline representation for ease of implementation and fine-grained control over shape and smoothness. A B-Spline curve is a linear combination of control points, pᵢ, and basis functions, N_{i,k}(t) and describes a piecewise polynomial curve where each segment has degree K, as shown for example in Equation 1, above.

The smoothness at the interface of pairs of segments is determined by the knot vector as shown for example in Equation 2.

$$T = ( {t}_{0} , {t}_{1} , … , {t}_{k - 1} , {t}_{k} , {t}_{k + 1} , … , {t}_{n - 1} , {t}_{n} , {t}_{n + 1} , … , {t}_{n + d} ) \qquad ( Eq . 2 )$$

A B-Spline curve does, in general, not pass through the two end control points. Only if a knot has multiplicity k−1, the corresponding control point will lie on the curve, reducing the continuity at that point to C⁰. By increasing the multiplicity of a knot to k, the curve is C⁻¹ and therefore discontinuous. In more general terms, a knot with multiplicity m results in a curve that is k−m−1-differentiable, and hence C^{k-m-1}, at the knot. The time interval may be normalized so that t∈[0,1].

In some examples, splines may display properties, such as local support. Knot span, tᵢ≤t≤tᵢ₊₁, is only affected by k control points, and a control point only has an effect on k spans. Adjustments to a control point, pᵢ, have an effect on the curve between t₁ and tᵢ₊ₖ. Additionally, splines may display smoothness. If the multiplicity of a knot is zero, a B-Spline curve is C^{k-1} and k−1-differentiable. Increasing the degree of the polynomial basis may increase the smoothness of the curve. Additionally, splines may display numerical stability. B-Splines may be numerically stable.

FIG. 2 illustrates an example method 200 for generating an output sequence 134 based on an input sequence 102 with a spline-based transformer 100. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

At operation 202, the spline-based transformer 100 receives an input sequence 102. In some examples, the input sequence 102 may be a text string, image, video, motion data, and the like. For example, the spline-based transformer 100 may receive an input sequence 102 from a user device (e.g., an external device 612 described with respect to FIG. 6), a datastore, and/or a computing system. For example, a user may input a text string via a user interface of a user device. The user device may communicate the text string to the spline-based transformer 100 as the input sequence 102. The spline-based transformer 100 may store the input sequence 102 in local memory, e.g., in a memory component 608 as described with respect to FIG. 6.

At operation 204, the spline-based transformer 100 generates an input token 110 based on the input sequence 102. The input token 110 may be one or more input tokens 110 in an embedded sequence of input tokens 112. The spline-based transformer 100 may encode the input sequence 102 with an artificial neural network encoder 104. The artificial neural network encoder 104 may tokenize the input sequence 102 to generate the one or more input tokens 110. For example, where the input sequence 102 is a text string, the artificial neural network encoder 104 may process and tokenize the input sequence 102 into text tokens; the artificial neural network encoder 104 may encode the input sequence 102 with an MLP to generate an embedded sequence of input tokens 112. In another example, where the input sequence 102 is an image, the artificial neural network encoder 104 may encode the input sequence 102 with a convolutional neural network (CNN) encoder that maps distinct, non-overlapping patches of the image to one or more dimensional latent input tokens 110 of a sequence of input tokens 112.

At operation 206, the spline-based transformer 100 generates a control token 106 based on the input sequence 102. The control token 106 may be one or more control tokens 106 in a sequence of control tokens 108. In some examples, the control token 106 may be a learned token generated by a machine learning or adaptive learning system. For example, a machine learning system implementing a spline-based transformer 100 may generate a learned token (e.g., a control token 106) based on the input sequence 102 to represent a feature of the input sequence 102. The control token 106 may include contextual and/or positional information of the input sequence 102. In some examples, the learned token is a classify token (e.g., a CLS token) that contains a classification and/or information representative of the input sequence 102. In some examples, the spline-based transformer 100 may append the sequence of control tokens 108 to the sequence of input tokens 112. In some embodiments, the number of control tokens 106 may be one less than the order of the spline. For example, a cubic spline may be based on two control tokens 106.

At operation 208, the spline-based transformer 100 generates a control point 116 based on the input token 110 and control token 106 via the transformer encoder 114. The control point 116 may be one or more control points 116 in a sequence of control points 116. The spline-based transformer 100 may append the ordered sequence of control tokens 108 to the sequence of input tokens 112. The spline-based transformer 100 may then encode the concatenated sequence of control tokens 108 and sequence of input tokens 112 with a transformer encoder 114 to generate a control point 116. The transformer encoder 114 may be a sequence to sequence (seq2seq) encoder. For example, the spline-based transformer 100 may append n control tokens 106 to the sequence of input tokens 112. A seq2seq transformer encoder 114 may then encode the concatenated sequence of input tokens 112 and n control tokens 106 to generate a sequence of n+1 control points 116. In some examples, the control points 116 may be used to evaluate a latent spline at the output of the transformer encoder 114. Latent codes corresponding to each control point 116 may be produced by evaluating the spline at the control point's 116 position.

At operation 210, the spline-based transformer 100 generates a spline, such as a latent spline trajectory 122 based on the control point 116. In some embodiments, the latent spline trajectory 122 represents a piecewise polynomial curve that defines a curve or trajectory of the sequence of control points 118. The latent spline trajectory 122 is a continuous function in many embodiments. The latent spline trajectory 122 may be a dimensional trajectory in a latent space, where the trajectory encapsulates fundamental characteristics of the input sequence 102. For example, after the transformer encoder 114 generates a control point 116, a linear layer may map the control point 116 to a dimensional latent space. The spline-based transformer 100 may generate a spline defining a polynomial curve trajectory connecting the one or more control points 116 in the dimensional latent space. For example, the spline in the latent space may be parameterized with cubic Bézier curves, with four control points 116 per segment of the spline. Bézier curves are one instance of the B-Spline family, and may provide sufficient smoothness for the applications. In other examples, different parametric curve families may be utilized to generate the spline, including Lissajous, Hypotrochoids, etc.

The resulting latent spline trajectory 122, has several advantages compared to a traditional positional encoding. First, the latent code is not perturbed by positional information, meaning the transformer decoder 126 and/or the artificial neural network decoder 132 may not need to learn to distinguish between positional and contextual information. Second, when using sinusoidals to encode the position of tokens, the contextual part of the token remains fixed and therefore provides a form of redundancy; the latent spline trajectories encode the temporal information implicitly, e.g., it can traverse the latent space faster in certain points and slower in others, making better use of the latent space. Third, the spline-based transformers allow users to manipulate the transformer by directly interacting with corresponding latent controls, thereby introducing a new means of interacting with this architecture not available in existing transformer models. For example, a user may manipulate a temporal characteristic of the input sequence by adjusting a position and/or a value of the plurality of control points within the latent space.

In some examples, the exact number of evaluations of the latent spline trajectory 122 depends on the number of output tokens expected at the decoder's (e.g., the transformer decoder 126) output. In one or more layers of the transformer, an attention bias may be added. Each layer, except the last MLP of the decoder, may use a Gaussian error linear units activation. In some examples, the transformer blocks may follow the structure of a transformer model. In other examples, any transformer block could be used in combination with the spline-based latent space. Depending on the complexity of the data type, transformer blocks of varying feature dimensions and capacities may be used. An optimizer with a cosine annealing learning rate scheduler may be used to train the spline-based transformer autoencoder.

At operation 212, the spline-based transformer 100 interpolates the spline. The spline is interpolated at one or more points in the latent space to generate one or more interpolated control points 120. The interpolated control points 120 may include information representative of the trajectory of the spline in the latent space. For example, the spline-based transformer 100 may evaluate the spline at various points along the trajectory of the spline to generate interpolated control points 120 representative of the spline at each point of evaluation. The number of evaluations of the spline may depend on the number of output tokens expected at the transformer decoder's 126 output. In some examples, the spline-based transformer 100 may uniformly sample the spline and evaluate the spline at uniform intervals.

At operation 214, the spline-based transformer 100 generates an output sequence 134. The interpolated control points 120 are decoded by the transformer decoder 126 to generate a sequence of output tokens 130 including one or more output tokens 128. For example, the transformer decoder 126 may process the spline trajectory represented by the interpolated control points 120 to generate output tokens 128 that achieve a sequence to sequence task. In some examples, the transformer decoder 126 may use the same structure as the transformer encoder 114. For example, the transformer encoder 114 and transformer decoder 126 may have the same number of layers, and each layer may have the same number of heads, and feature dimensions. The sequence of output tokens 130 may then be processed by the artificial neural network decoder 132 to generate an output sequence 134. In some examples, the artificial neural network decoder 132 may process the sequence of output tokens 130 to reconstruct the original input sequence 102.

FIG. 3 illustrates a table of examples of outputs of the spline-based transformer 100 compared to two prior methods. Examples conducted with a number of datasets demonstrate the effectiveness of the spline-based transformer 100 when applied to multiple modalities of sequential data. The examples compare the spline-based transformer 100 against ALiBi, a prior transformer model that uses a combination of both absolute and relative positional encoding. Because ALiBi adds sinusoids to the input token embedding, which could create an ambiguity between the token's content and position for the transformer decoder to disentangle, the examples also compare the spline-based transformer 100 against ALiBi with conformal anomaly detection (ALiBi-Cat), a variation of ALiBi, where the sinusoids are concatenated with the token embedding, effectively doubling the size of the transformer decoder blocks. The spline-based latent space differs from the two baselines; ALiBi uses a single control point and adds positional information on top to create a latent sequence, while ALiBi-Cat concatenates the control point and the positional information instead.

In the examples the latent space between the encoder and decoder blocks are parameterized with cubic Bézier curves, with four control points per segment. Bézier curves are one instance of the B-Spline family, and provide sufficient smoothness for the applications. The latent spline trajectory are uniformly sampled in the range t∈[0,1].

As illustrated in FIG. 3, the examples evaluate the spline-based transformer 100, ALiBi, and ALiBi-Cat in representing parametric 2D curves that have a known latent space size. This task uses three different parametric curve families: (1) Lissajous (d=3), (2) Hypotrochoids (d=4), (3) Bézier curves (with d=2, and d=64). For each curve type, the example evaluates three different transformer autoencoders for the spline-based transformer 100, ALiBi, and ALiBi-Cat, respectively. The network parameters for the different autoencoders are identical, with the only difference being the mechanism used to derive latent token trajectories. The dimensionality of the latent token embedding is decided based on the known latent space of the curve family. The three transformer autoencoders are trained independently on each curve family by randomly sampling curve parameters according to the parameterization of the curve in a pre-determined domain. Using the sampled parameters, the example evaluates the curve to create a sequence of 256 2D tokens that contain the (x, y) coordinates of the curve, which are then input to the transformer encoder 114. The three transformer autoencoders are trained end-to-end using a simple L2 reconstruction objective. Table 1 shows an example of the reconstruction error of each of the transformer models when presented with 10,000 unseen curves from the family it was trained on. The spline-based transformer 100 outperforms ALiBi and ALiBi-Cat, especially on low dimensional latent spaces. See, e.g., results from Table 1 showing the present disclosure having four orders of magnitude less error in the 2D Bézier test.

TABLE 1
Example of average reconstruction
error of 10,000 test curves in 2D.

| | Lissajous | Hypotrochoids | Bezier | Bezier |
|---|---|---|---|---|
| Method | (3D) | (4D) | (2D) | (64D) |
| ALiBi | 1e−4 | 2e−3 | 1.76e−2 | 3.88e−3 |
| ALiBi-Cat | 8e−4 | 5.3e−3 | 1.78e−2 | 3.89e−3 |
| Present | 3e−5 | 1.4e−3 | 2e−6 | 3.87e−3 |
| disclosure | | | | |

Qualitative comparisons of the examples are shown in FIG. 3, illustrating that the spline-based transformer 100 can successfully reconstruct curves of different families with consistently better performance than ALiBi and ALiBi-Cat. For example, as portrayed in FIG. 3, the spline-based transformer 100 can successfully reconstruct curves of different families with consistently better performance than ALiBi and ALiBi-Cat. In certain scenarios such as displayed in the third row of FIG. 3 representing the Bézier curves, reconstructions from ALiBi and ALiBi-Cat can collapse to a single point, while the spline-based transformer 100 recovers the input curve.

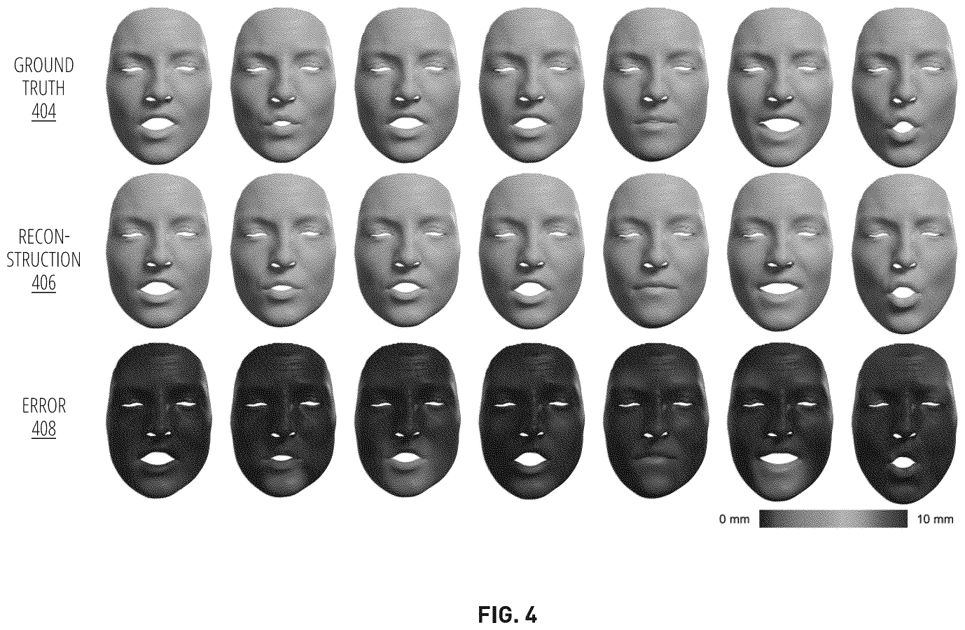

In another example, a commonly encountered modality of sequential data is 3D animation. A spline-based transformer 100, when used to represent 4D data, like a sequence of 3D meshes from a facial animation or a sequence of joint poses describing human motion, can lead to notable performance benefits over older transformers. FIG. 4 illustrates an example of a plurality of facial expression animation reconstructions generated with the spline-based transformer 100. In addition to the examples described with respect to FIG. 3, further examples demonstrate the effectiveness of the spline-based transformer 100 in reconstructing 3D facial animations. The example portrayed in FIG. 4 compares the performance of the spline-based transformer 100 transformer encoder 114 against ALiBi, and ALiBi-Cat, training the three models on a database of 3D facial animations. Each animation is represented by a sequence of registered 3D meshes. The example decimates these meshes such that they contain around 5,000 vertices, and the vertices are flattened to a vector. A flattened animation sequence is thereafter split into windows of size 30 (˜1 second of animation) and used to train three variations of the transformer encoder 114. Irrespective of the dimensionality of the latent space, the spline-based transformer 100 outperforms both ALiBi and ALiBi-Cat. The ALiBi transformer decoder used in these examples is conceptually similar to the ones used in previous works, indicating that spline-based transformers 100 could lead to improved performance in several downstream tasks.

FIG. 4 illustrates a qualitative visualization of a reconstructed test performance for the 64 dimension spline-based transformer 100. The spline-based transformer 100 is able to successfully represent facial animations, preserving both the identity and expression of the subject throughout the performance. Ground truth 404 represents a sequence of ground truth 3D meshes. Reconstruction 406 represents a sequence of 3D meshes reconstructed by the spline-based transformer 100 based on the ground truth 404. Error 408 represents a sequence of 3D meshes visualization of the error value of the reconstruction 406 in comparison to the ground truth 404. The error value is defined by the color key. Example results are summarized in Table 2, again showing the spline-based transformer 100 outperforming older methods.

TABLE 2
Face Performance Reconstruction. Comparison across different
latent dimensions. Bold indicates the best overall performance,
and underline the best in each category. Performance
is measured in Mean Squared Error (MSE).

| Method | 32D | 64D | 128D | 256D |
|---|---|---|---|---|
| ALiBi | 1.58 | 1.55 | 1.48 | 1.54 |
| ALiBi-Cat | 1.60 | 1.54 | 1.53 | 1.50 |
| Present | 1.43 | 1.35 | 1.47 | 1.47 |
| disclosure | | | | |

In an example similar to that of FIG. 4, reconstructing still images instead of animations, the input sequence 102 of 2D image patches each having a patch size (PS) is input to the transformer encoder 114. In such embodiments, the artificial neural network encoder 104 may be a CNN encoder that maps each patch to a d-dimensional latent token (1,d). An image having height and width (H,W) may be represented with a sequence of size (HW/PS²,d). The rest of the transformer autoencoder 114 may be the same as described herein. The transformer autoencoder 114 may be trained using an L2 reconstruction loss to recover the input image from the patch input sequence 102. Table 3 shows example results from image reconstruction to compare the performance of the spline-based transformer 100 against ALiBi and ALiBi-Cat.

TABLE 3
Image Reconstruction. Comparison across different datasets and bottleneck dimensions.
Bold indicates the best overall performance, and underline the best in each
category. Performance is measured in Mean Squared Error (MSE).

| | | CIFAR-10 | | | AFHQ | | | Faces | |
|---|---|---|---|---|---|---|---|---|---|
| Method | 32D | 64D | 128D | 32D | 64D | 128D | 32D | 64D | 128D |
| ALiBi | 0.266 | 0.178 | 0.107 | 0.064 | 0.050 | 0.038 | 10.65e−3 | 8.56e−3 | 6.71e−3 |
| ALiBi-Cat | 0.264 | 0.174 | 0.108 | 0.064 | 0.049 | 0.038 | 10.87e−3 | 8.56e−3 | 7.14e−3 |
| Present | 0.107 | 0.056 | 0.042 | 0.038 | 0.030 | 0.025 | 6.77e−3 | 5.27e−3 | 4.52e−3 |
| disclosure | | | | | | | | | |

Table 3 includes results on reconstructing three different image datasets: the publicly available Canadian Institute for Advanced Research (CIFAR-10) dataset (32×32), Animal Faces HQ (AFHQ) dataset (128×128), and a dataset containing facial images (128×128) (shown for example in FIG. 4). For each dataset and method, the transformers may be trained with three different latent sizes: 32D, 64D, and 128D. As shown in Table 3, the spline-based transformer 100 significantly outperforms both ALiBi and ALiBi-Cat by a factor of 2. FIG. 4. shows examples of the reconstructed images and their corresponding error maps. The spline-based transformer 100 results in sharper and more detailed images compared to the older transformers. Furthermore, the performance improvements of the spline-based transformers 100 are larger for lower dimensional latent spaces.

In another example, the spline-based transformers 100 disclosed can be used to full-body motion or animation. Table 4, includes a summary of results for full body (e.g., human) motion reconstruction. The table shows the mean squared reconstruction error of per-frame joint positions measured in degrees. The spline-based transformer 100 shows reconstruction improvements of at least a factor two over older methods, reducing the mean joint error of the smallest model (16D) from 0.4° to 0.2°, and up to ˜0.07° for the largest model (64D).

TABLE 4
Human Motion Reconstruction. Comparison across different latent
dimensions. Bold indicates the best overall performance, and
underline the best in each category. Results are reported as
Mean Squared Error (MSE) between joint angles [deg].

| Method | 16D | 32D | 64D |
|---|---|---|---|
| ALiBi | 0.151 | 0.103 | 0.059 |
| ALiBi-Cat | 0.153 | 0.103 | 0.051 |
| Present | 0.054 | 0.022 | 0.006 |
| disclosure | | | |

In another example, spline-based transformers 100 may be used to modify motions e.g., by applying simple operations to the control points 116. The output from a spline-based transformer 100 may be manipulated by adjusting at least one of a position or a value of the plurality of control points 116 within the latent space. For example, motions output from the spline-based transformer 100 may be modified by moving the control points 116 closer or further away from the end points of the spline. The output motions preserve the overall style but change in a temporal characteristic such as speed and/or trajectory and/or a quality characteristic such as detail. This example shows that spline-based transformers behave smoothly in a neighborhood and edits result in plausible motions. Motions can easily be toned down or amplified based on modifying the control points 116. The spline-based latent space further allows users to super-sample motions. By sampling the spline more densely before decoding, users can achieve up to a 4× upsampling of a motion clip. This method effectively preserves the original motion characteristics but with higher resolution. Multiple splines can be combined to represent longer sequences of motions. Each of the segments can then be modified individually. In some embodiments, modifying a control point 116 affects a limited portion or segment of the latent spline trajectory 122. Thus, the spline-based transformer 100 can be highly customized to a given application.

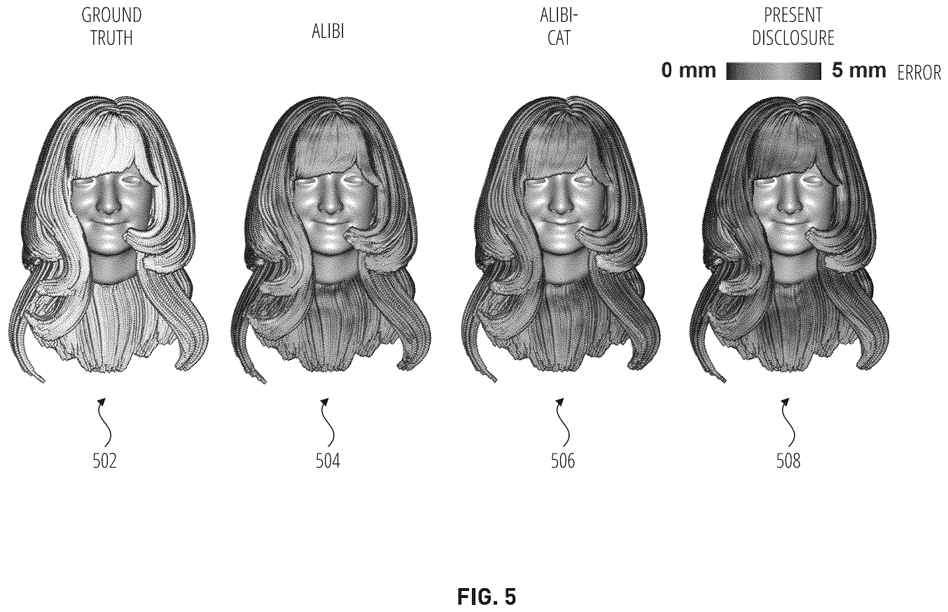

FIG. 5 illustrates examples of reconstructing a character using a spline-based transformer 100 compared to two prior methods, the ALiBi and ALiBi-Cat methods described with respect to FIG. 3. In addition to the examples described with respect to FIG. 3 and FIG. 4, further examples demonstrate the effectiveness of the spline-based transformer 100 in modeling complex geometry like hair strands, which present themselves as 3D curves in space. The example portrayed in FIG. 5 compares the performance of the spline-based transformer 100 against ALiBi, and ALiBi-Cat. The example uses a dataset of three hundred forty-three unique 3D hairstyles, where each hairstyle contains ten thousand strands, and each strand has one hundred points. The example represents only the strand geometry, so the strands across the hairstyles are considered as individual 3D curves in space. The root position of each strand is normalized by translating it to the origin. Each normalized strand is therefore a sequence of one hundred vertices and is used to train the transformer encoder 114 of the spline-based transformer 100 with an L2 reconstructive loss. While a thorough comparison to state-of-the-art methods is required to demonstrate the real effectiveness of the spline-based transformer 100 for this task, initial tests indicate that spline-based transformers 100 may be an architectural alternative. Spline-based transformers 100 not only achieve a better performance than conventional transformers as demonstrated by the examples, but the spline-based transformer 100 can also perform faster than the traditional positional encoded models.

FIG. 5 illustrates a visual reconstruction of the strands as a coherent hairstyle. Ground truth 502 represents the ground truth root position of the reconstructed strands. Reconstruction 504 represents a reconstruction of the strands using the ALiBi method. Reconstruction 506 represents a reconstruction of the strands using the ALiBi-Cat method. Reconstruction 508 represents a reconstruction of the strands using the spline-based transformer 100. The error value of each reconstruction in comparison with the ground truth 502 is indicated by the colors displayed on the strands, and the error value is defined by the color key. Examples of results of the example of FIG. 5 are shown in Table 5, again showing the spline-based transformer outperforming older models.

TABLE 5
Strand Reconstruction. Comparison across different latent
dimensions. Bold indicates the best overall performance,
and underline the best in each category. Performance
is measured in Mean Squared Error (MSE).

| Method | 8D | 16D | 32D |
|---|---|---|---|
| ALiBi | 4.8e−3 | 2.0e−3 | 1.5e−3 |
| ALiBi-Cat | 4.6e−3 | 1.9e−3 | 1.2e−3 |
| Present | 1.09e−3 | 1.06e−3 | 9.4e−4 |
| disclosure | | | |

FIG. 6 is a simplified block diagram of components of a computing system 600 of the system 100, such as a computing system used to implement the spline-based transformer 100. For example, the processing element 602 and the memory component 608 may be located at one or in several computing systems 600. This disclosure contemplates any suitable number of such computing systems 600. For example, the computing system 600 may be a desktop computing system, a mainframe, a blade, a mesh of computing systems 600, a laptop or notebook computing system 600, a tablet computing system 600, an embedded computing system 600, a system-on-chip, a single-board computing system 600, or a combination of two or more of these. Where appropriate, a computing system 600 may include one or more computing systems 600; be unitary or distributed; span multiple locations; span multiple machines; span multiple data centers; or reside in a cloud, which may include one or more cloud components in one or more networks. A computing system 600 may include one or more processing elements 602, an input/output I/O interface 604, one or more external devices 612, one or more memory components 608, and a network interface 610. Each of the various components may be in communication with one another through one or more buses or communication networks, such as wired or wireless networks, e.g., a network. The components in FIG. 6 are exemplary only. In various examples, the computing system 600 may include additional components and/or functionality not shown in FIG. 6.

The processing element 602 may be any type of electronic device capable of processing, receiving, and/or transmitting instructions. For example, the processing element 602 may be a central processing unit, microprocessor, processor, or microcontroller. Additionally, it should be noted that some components of the computing system 600 may be controlled by a first processing element 602 and other components may be controlled by a second processing element 602, where the first and second processing elements may or may not be in communication with each other.

The I/O interface 604 allows a user to enter data in to computing system 600, as well as provides an input/output for the computing system 600 to communicate with other devices or services. The I/O interface 604 can include one or more input buttons, touch pads, touch screens, and so on.

The external device 612 are one or more devices that can be used to provide various inputs to the computing systems 600, e.g., mouse, microphone, keyboard, trackpad, sensing element (e.g., a thermistor, humidity sensor, light detector, etc.) The external devices 612 may be local or remote and may vary as desired. In some examples, the external devices 612 may also include one or more additional sensors.

The memory components 608 are used by the computing system 600 to store instructions for the processing element 602 such as instructions to execute the spline-based transformer 100, microclimate conditions, environmental characteristics, user preferences, alerts, etc. The memory components 608 may be, for example, magneto-optical storage, read-only memory, random access memory, erasable programmable memory, flash memory, or a combination of one or more types of memory components.

The network interface 610 provides communication to and from the computing system 600 to other devices. The network interface 610 includes one or more communication protocols, such as, but not limited to Wi-Fi, Ethernet, Bluetooth, etc. The network interface 610 may also include one or more hardwired components, such as a Universal Serial Bus (USB) cable, or the like. The configuration of the network interface 610 depends on the types of communication desired and may be modified to communicate via Wi-Fi, Bluetooth, etc.

The display 606 provides a visual output for the computing system 600 and may be varied as needed based on the device. The display 606 may be configured to provide visual feedback to a user and may include a liquid crystal display screen, light emitting diode screen, plasma screen, or the like. In some examples, the display 606 may be configured to act as an input element for the user through touch feedback or the like.

As disclosed herein, spline-based transformers are a class of transformer models which eliminate the need for absolute positional encoding by combining temporal and contextual information into a single trajectory, represented by a latent spline curve. Examples show the improved performance of spline-based transformers across a variety of datasets, from simple curves to complex animation data and images. The examples show significant performance improvements over traditional positional encoded transformer models. Spline-based transformers may be simple to implement yet effective and have no additional computational overhead. The spline-based latent space disclosed herein may provide a method to interact with latent spaces using straightforward modifications of the latent control points.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method for generating an output sequence of data utilizing a spline-based transformer, comprising:
encoding, via a processing element, an input sequence of data using an artificial neural network encoder to generate a plurality of input tokens;
processing, via the processing element, the plurality of input tokens and a plurality of control tokens with a transformer encoder into a latent space to generate a plurality of control points;
defining, via the processing element, a spline based on the plurality of control points;
sampling, via the processing element, a plurality of interpolated control points based on the spline; and
decoding, via the processing element, the interpolated control points with an artificial neural network decoder to generate the output sequence of data.

2. The method of claim 1, wherein the processing step comprises appending the plurality of control tokens to the plurality of input tokens.

3. The method of claim 1, further comprising determining a plurality of respective weights of the plurality of control points based on a basis function, wherein the spline comprises a weighted sum based on the plurality of respective weights.

4. The method of claim 1, further comprising learning, via the processing element, the plurality of control tokens.

5. The method of claim 1, wherein the spline comprises a continuous latent space trajectory.

6. The method of claim 5, wherein the trajectory encapsulates a characteristic of the input sequence of data.

7. The method of claim 1, wherein the sampling step comprises uniformly or non-uniformly discretizing the spline.

8. The method of claim 1, further comprising deriving, via the processing element, embeddings for the plurality of input tokens before processing the plurality of input tokens and the plurality of control tokens with the transformer encoder.

9. The method of claim 1, further comprising manipulating, via the processing element, the output sequence of data by adjusting at least one of a position or a value of the plurality of control points within the latent space.

10. The method of claim 9, wherein the manipulating adjusts a temporal characteristic of output sequence of data.

11. The method of claim 10, wherein the temporal characteristic comprises at least one of a speed or trajectory change in the output sequence of data.

12. The method of claim 1, wherein the spline comprises a B-spline.

13. The method of claim 10, wherein an alteration to a control point of the plurality of control points affects a limited segment of the trajectory.

14. A non-transitory computer-readable storage medium, the computer-readable storage medium including instructions that when executed by a computer, cause the computer to:
encode an input sequence of data using an artificial neural network encoder to generate a plurality of input tokens;
process the plurality of input tokens and a plurality of control tokens with a transformer encoder into a latent space to generate a plurality of control points;
define a spline based on the plurality of control points;
sample a plurality of interpolated control points based on the spline; and
decode the interpolated control points with an artificial neural network decoder to generate an output sequence of data.

15. The method of claim 14, wherein the processing step comprises appending the plurality of control tokens to the input tokens.

16. The method of claim 14, further comprising determining a plurality of respective weights of the plurality of control points based on a basis function, wherein the spline comprises a weighted sum based on the plurality of respective weights.

17. The method of claim 14, further comprising learning, via the processing element, the plurality of control tokens.

18. The method of claim 14, wherein the spline comprises a continuous latent space trajectory.

19. The method of claim 18, wherein the trajectory encapsulates a characteristic of the input sequence of data.

20. A method for generating an output sequence of data utilizing a spline-based transformer, comprising:
processing, via a processing element, a plurality of input tokens and a plurality of control tokens with a transformer encoder into a latent space to generate a plurality of control points;
defining, via the processing element, a spline based on the plurality of control points;
interpolating, via the processing element, a plurality of interpolated control points based on the spline; and
decoding, via the processing element, the interpolated control points to generate the output sequence of data.
